(19) United States
(12) Patent Application Publication
(10) Pub. No.: US 2007/0190301 A1
(43) Pub. Date: Aug. 16, 2007

(54) Upholstery part, in particular equipment for the interior of a motor vehicle for producing said part and seat

(75) Inventor: Philippe Saulnier, Gimbrett-Brestett (FR)

Correspondence Address: FOLEY & LARDNER LLP, 777 EAST WISCONSIN AVENUE, MILWAUKEE, WI, 53202-5306, US

(73) Assignee: Cellpoint Connect ApS

(21) Appl. No.: 10/568,725

(22) PCT Filed: Aug. 14, 2004
(86) PCT No.: PCT/EP04/09143

§ 371 Date: Dec. 13, 2006

(30) Foreign Application Priority Data
Aug. 20, 2003 (DE) 103 38 215.1

(51) Int. Cl. B29C 65/00; B29C 67/00; B32B 3/26; B32B 5/14; B32B 9/00

(52) U.S. Cl. 428/304.4; 428/308.4; 428/318.4; 264/41; 264/46.4

(57) ABSTRACT

The present vehicle seat includes an upholstery part having a foam body and a protective coating at least partially covering a surface of the foam body. The coating prevents the foam from being damaged by contact with the metal structure of the seat. The coating contains a substance that can be applied to the foam body in liquid form and cured thereafter. Fibers can be added to the protective coating and applied with the protective coating or separately. The protective coating can be applied directly to the pre-formed upholstery part or can be applied prior to the foaming process to the relevant cavity of the foam mold.

### CROSS-REFERENCE TO RELATED PATENT APPLICATIONS

This is a National Stage Application of PCT/EP2004/009143 entitled, “Upholstery Part, in Particular for Equipping the Interior of a Motor Vehicle, Method for Producing said Part and Seat” filed on Aug. 14, 2004 which published under PCT Article 21(2) on Mar. 3, 2005 as WO 2005/018916 A1 in the German language, which claims priority to German Patent Application No. DE 103 38 215.1 filed on Aug. 20, 2003, the disclosures of which are incorporated herein by reference in their entirety.

### TECHNICAL FIELD

The present application relates to an upholstery part, in particular for the seat of a motor vehicle, with a foam body and a protective layer arranged at least in partial regions of its surface, a method suitable for producing an upholstery part and also a seat equipped with such an upholstery part, in particular a vehicle seat.

### BACKGROUND

An upholstery part is disclosed in patent document DE 44 38 018 A1. The aircraft seat disclosed therein is equipped with a seat padding which is provided on its underside with a protective layer similar to a woven fabric and, according to a particular embodiment, with an additional intermediate layer of a knitted fabric, mesh or gauze. These layers protect the upholstery part during use of the seat, under the associated mechanical loads, from being damaged by the metallic supporting structure of the seat or a spring core located in the upholstery.

The protective layer can be bonded to the upholstery part by means of adhering the protective layer to the upholstery part at locations distanced from one another. It is also known from the practical production of motor vehicle seats to insert prefabricated blanks of woven fabric into the foaming mold and bond them to the upholstery part by foam encapsulation.

Both methods lead to a usable result, but are very labor-intensive.

### SUMMARY

One exemplary embodiment relates to an upholstery part that includes a foam body; and a protective layer arranged at least a partial region of a foam body surface. The protective layer contains a material that can be applied in liquid form and cured.

Another exemplary embodiment relates to a method for producing an upholstery part, the method includes filling a foamable compound into a mold; making the compound foam to form a molded part; and removing the molded part from the mold to produce the upholstery part. The upholstery part is provided at least in a partial region of an upholstery part surface with a protective layer of a curable material that can be applied in liquid form.

Another exemplary embodiment relates to a vehicle seat, that includes an upholstery part having a foam body moldable in a mold, and a protective coating at least partially covering a surface of the foam body. The coating may be applied in liquid form to the mold or the foam body surface and cured thereafter.

Another exemplary embodiment relates to an upholstery part, that includes a foam body moldable in a mold and a protective coating at least partially covering a surface of the foam body. The coating is applied in liquid form to at least one of the mold and the foam body surface and cured thereafter.

Another exemplary embodiment relates to a method for producing an upholstery part, that includes providing a mold cavity; applying a protective coating in liquid form to at least a region of the mold cavity; filling a foamable compound into the mold cavity; making the foamable compound foam; and curing the protective coating.

Another exemplary embodiment relates to a method for producing an upholstery, that includes providing a molded part; applying a protective coating in liquid form to at least a region of a surface of the molded part; and curing the protective coating.

### BRIEF DESCRIPTION OF THE DRAWINGS

The figures represent an embodiment/embodiments of the invention schematically and by way of example. The disclosure is explained in more detail below with reference to exemplary embodiments illustrated in the drawings.

FIG. 1 is a schematic and shows application of a protective layer to an upholstery part of a vehicle seat, according to an exemplary embodiment.

FIG. 2 is a schematic and shows application of a curable liquid to a mold cavity, according to an exemplary embodiment.

FIG. 3 is a bottom perspective view of an upholstery part made by the method that is shown in FIG. 2, according to an exemplary embodiment.

### DETAILED DESCRIPTION

An upholstery part, such as a vehicle seat, can have a surface protected against mechanical damage and can be produced with reduced effort.

The upholstery part, which can be of a generic type, can have a protective layer containing a material that can be applied as a liquid and cured.

The protective layer is arranged on partial regions of the upholstery part that are subjected to frictional loading, in particular facing the metal structure of a seat. The foam body as such consists of an open-cell polymer foam, in particular polyurethane, which is conducive for climatically comfortable sitting. Since the protective layer is applied to the foam body only partially and not on the surface facing the occupant of the seat, the climatic sitting conditions are largely unaffected.

The protective layer contains a polymer, in particular a radically polymerizable polymer. Particularly suited is a polyvinyl acetate (PVA), which can be applied as a liquid with a viscosity of 0.1 to 1.0 Pa s/20° C. To improve the abrasion characteristics, the protective layer may also contain fibers, in particular of polyamide or glass, which comprise pieces of fiber, with a length of 10 to 100 mm, for example, 25 to 75 mm, in particular approximately 50 mm, and are arranged substantially randomly in the protective layer. The fiber content in the protective layer is in this case 5 to 20% by weight, e.g., in particular approximately 10% by weight. It is generally adequate if the protective layer has a maximum thickness of 0.05 to 0.5 mm, for example, 0.1 to 0.25 mm in thickness.

A protective layer of this type can be applied to the relevant surfaces of the upholstery part in an automated manner.

Likewise solving the defined problem, a method for producing an upholstery part in which a foamable compound is filled into a mold, the compound is made to foam to form a molded part, and the part is subsequently de-molded, is characterized in that the upholstery part is provided at least in partial regions of its surface with a protective layer of a curable material that can be applied in liquid form.

The curable material is in this case applied, in particular sprayed, onto at least a partial region of the mold surface, before the foamable compound is introduced, and/or to the molded part after the foaming of the compound.

In this case, fibers, in particular pieces of fiber, may be added to the curable material, the fibers being fed as continuous strands (rovings) to an application tool, cut there and subsequently applied as pieces of fiber.

At the same time, the curable material may be fed to the application tool in liquid form, which material fixes the fibers or pieces of fiber in their position on the mold surface and/or the molded part.

The application of the curable material may take place in a number of layers, the number of layers varying from location to location. In this case, each layer may be of the same thickness, which is particularly favorable for application, but nevertheless the resistance of the protective layer can be adapted to the local requirements. It is also possible to adapt the fiber content in the protective layer correspondingly.

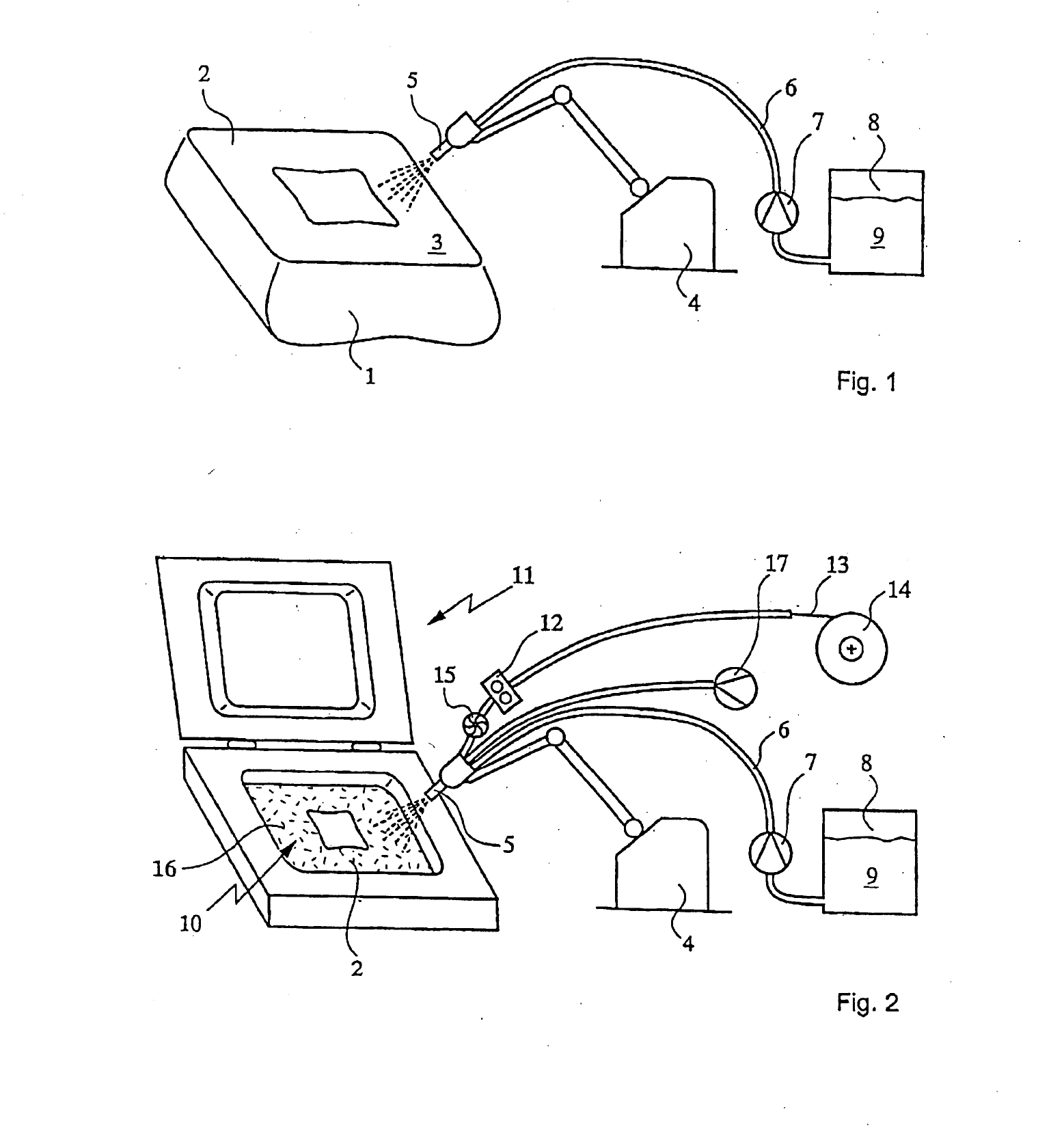

In the procedure represented in FIG. 1, an upholstery part 1 is produced in a conventional way by making a mixture of polyol and isocyanate foam in a foaming mold and the part is subsequently de-molded. Similarly, by squeezing the upholstery part, the foam structure may subsequently be modified in such a way that it has substantially open cells, i.e. cells that communicate with one another.

In order to provide the upholstery part 1 with a protective layer 3 in the regions 2 on the rear side where it later comes into contact with the metal structure of the vehicle seat, an industrial robot 4 is used to move, over the upholstery part 1,—a nozzle 5, which is fed from a tank 8, via a hose line 6 and a pump 7, with a curable polyvinyl acetate (PVA), which can be applied as a liquid 9. The liquid penetrates into the uppermost regions of the upholstery part 1 and, after curing, forms an abrasion-resistant protective layer 3, which is permanently bonded to the upholstery part 1 and the thickness of which may be less than 0.1 mm. If locally greater thicknesses are required, they can be produced by repeated spraying of the upholstery part. If the industrial robot 4 has the appropriate capability, it is of course possible to provide not only planar areas but also three-dimensional moldings with a corresponding protective layer 3.

In the case of the method that is shown in FIG. 2, before the foamable compound is introduced, the liquid 9 that later cures to form the protective layer 3 is sprayed locally into the cavity 10 of a multipart foaming mold 11, on the surface of which there forms a tacky film. By means of a conveying device 12, continuous strands of fiber (rovings) 13 are also fed to the nozzle 5 from a reel 14 via a line. In a cutting unit 15, these rovings are cut up into pieces of fiber 16 before entering the nozzle 5 and are applied together with the liquid 9. Compressed air is fed into the nozzle 5 by means of a blower 17 and in this case assists the application of the protective layer 3 onto the surface of the foaming mold 11. If need be, a release wax that facilitates later de-molding is also applied to the surface of the cavity 10 before the curable liquid is sprayed on. If appropriate, the release wax and the liquid 9 may be applied one after the other by the same industrial robot 4.

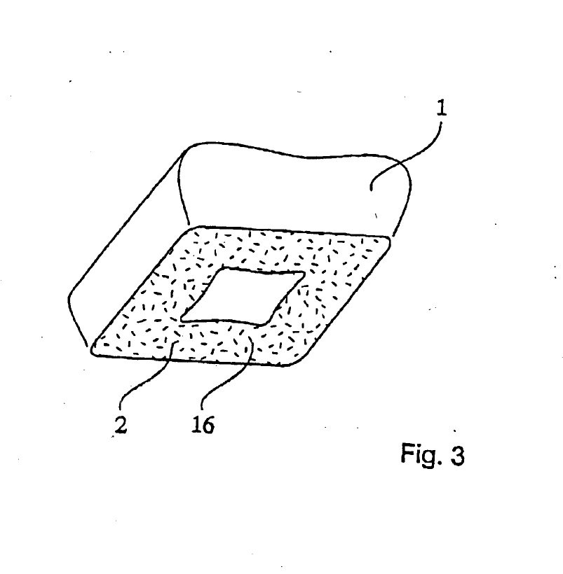

After the foaming mold 11 is closed, the foamable compound is filled into the cavity 10. The de-molded upholstery part, as shown in FIG. 3, is provided having the protective layer 3 on the relevant or predetermined regions 2, in which the pieces of fiber 16 are randomly embedded. The bond between the upholstery part 1 and the protective layer 3 is adequately strong to withstand later handling for opening the cell structure.

In principle, it is of course possible to use both methods one after the other on the same upholstery part.

1-19. (canceled)

20. An upholstery part, comprising:
a foam body; and
a protective layer arranged at least at a partial region of a foam body surface;
wherein the protective layer contains a material that can be applied in liquid form and cured.

21. The upholstery part of claim 20, wherein the protective layer is arranged at at least one partial region of the upholstery part subjected to frictional loading, wherein the partial region subject to frictional loading faces a metal structure of the seat.

22. The upholstery part of claim 20, wherein the foam body comprises an open-cell polymer foam, wherein the open-cell polymer foam is polyurethane.

23. The upholstery part of claim 20, wherein the protective layer comprises a polymer, wherein the polymer is a radically polymerizable polymer.

24. The upholstery part of claim 20, wherein the protective layer comprises polyvinyl acetate.

25. The upholstery part of claim 20, wherein the curable material of the protective layer is applicable as a liquid with a viscosity between 0.1 to 1.0 Pa s/20° C.

26. The upholstery part of claim 20, wherein the protective layer comprises fibers, wherein the fibers are composed of polyamide or glass.

27. The upholstery part of claim 26, wherein the fibers have a length in the range of 10 to 100 mm.

28. The upholstery part of claim 26, wherein the fibers are arranged substantially randomly in the protective layer.

29. The upholstery part of claim 26, wherein the fiber content in the protective layer is 5 to 20% of the weight of the protective layer.

30. The upholstery part of claim 20, characterized in that the maximum thickness of the protective layer is between 0.05 to 0.5 mm.

31. A method for producing an upholstery part, comprising:
filling a foamable compound into a mold;
making the compound foam to form a molded part; and
removing the molded part from the mold to produce a portion of the upholstery part;
wherein the upholstery part is provided at least in a partial region of an upholstery part surface with a protective layer of a curable material that can be applied in liquid form.

32. The method of claim 31, wherein the curable material is sprayed onto at least a partial region of a surface of the mold before the foamable compound is filled in the mold.

33. The method of claim 31, wherein the curable material is sprayed onto the molded part after making the compound foam.

34. The method of claim 31, wherein fibers are added to the curable material.

35. The method of claim 31, wherein fibers are fed as continuous strands to an application tool and cut and subsequently applied as pieces of fiber to the upholstery part surface.

36. The method of claim 31, wherein fibers and the curable material in liquid form are fed simultaneously to an application tool to be applied to the upholstery part surface.

37. The method of claim 31, wherein the curable material is applied to the upholstery part surface in layers, the number of layers varying from location to location.

38. A vehicle seat, comprising:
an upholstery part, including:
a foam body moldable in a mold; and
a protective coating at least partially covering a surface of the foam body,
wherein the coating is applied in liquid form to at least one of the mold and the foam body surface and cured thereafter.

39. The vehicle seat of claim 38, wherein the protective coating comprises fibers added to the liquid form.

40. An upholstery part, comprising:
a foam body moldable in a mold; and
a protective coating at least partially covering a surface of the foam body;
wherein the coating is applied in liquid form to at least one of the mold and the foam body surface and cured thereafter.

41. The upholstery part of claim 40, wherein the protective coating comprises fibers added to the liquid form.

42. A method for producing an upholstery part, comprising:
providing a mold cavity;
applying a protective coating in liquid form to at least a region of the mold cavity;
filling a foamable compound into the mold cavity;
making the foamable compound foam; and
curing the protective coating.

43. The method of claim 42, further comprising adding fibers to the liquid protective coating.

44. A method for producing an upholstery part, comprising:
providing a molded part;
applying a protective coating in liquid form to at least a region of a surface of the molded part; and
curing the protective coating.

45. The method of claim 44, further comprising adding fibers to the protective coating in liquid form.
